(19) United States
(12) Patent Application Publication
(10) Pub. No.: US 2018/0244302 A1
(43) Pub. Date: Aug. 30, 2018

(54) UTILITY VEHICLE STEERING SYSTEM

(71) Applicant: VOLKSWAGEN AKTIENGESELLSCHAFT, WOLFSBURG (DE)

(72) Inventors: JENS ROGALL, WOLFSBURG (DE); SEBASTIAN BENECKE, MAGDEBURG (DE)

(21) Appl. No.: 15/758,122

(22) PCT Filed: Aug. 22, 2016
(86) PCT No.: PCT/EP2016/069764

§ 371 Date: Mar. 7, 2018

(30) Foreign Application Priority Data
Sep. 7, 2015 (DE) 10 2015 217 051.9

(51) Int. Cl. B62D 5/04; B62D 3/10

(52) U.S. Cl. CPC B62D 5/0415; B62D 3/10

(57) ABSTRACT

A utility vehicle steering system has a steering gear for transmitting a manual torque that is applied to a steering wheel to a pitman arm. The steering gear has an electric motor for providing an auxiliary torque. The electric motor is arranged around a steering shaft. In addition, the electric motor has a stator with at least two electrically separated winding groups, each of which is controlled by a separate electronic control device. An especially compact utility vehicle steering system results, which enables the provision of large auxiliary torques by way of a single electric-motor drive while a limited installation space is achieved. The drive can be operated from a vehicle electrical system by a supply voltage of 24 V.

The invention relates to a utility vehicle steering system, comprising a steering gear for transmitting a manual torque applied to a steering wheel to a steering pitman arm, which steering gear has an electric motor for providing an auxiliary torque.

Utility vehicle steering systems must, by contrast to steering systems for passenger motor vehicles, provide considerably higher steering forces owing to the higher front axle loads, such that steering system concepts that are conventional for passenger motor vehicles cannot be transferred to utility vehicles. Furthermore, owing to the different spatial conditions in the vehicle, there is a considerably changed installation situation.

Utility vehicle steering systems are therefore often configured with a block-like steering gear, to the output side of which there is connected a steering pitman arm. A manual torque input into the steering gear at the input side by the driver is converted by said steering gear into a pivoting movement of the steering pitman arm.

DE 20 2004 021 588 U1 discloses a utility vehicle steering system which has both an electrical power assistance means and a hydraulic power assistance means. The manual torque input by the driver is in this case introduced via a torsion bar into a spindle which engages, via an endless ball chain, with an axially displaceable piston. A toothing provided on the outer circumference of the piston meshes with a drive-output segment shaft which is connected to the steering pitman arm for the purposes of converting the axial movement of the piston into a pivoting movement of the steering pitman arm. The torsion bar arranged within the spindle actuates, by means of a rotary slide, a valve arrangement of a hydraulic circuit. The hydraulic circuit generates a hydraulic pressure by means of a pump and acts on the piston, which provides an assistance force in addition to the manual torque. The electric power assistance is provided by means of an electric motor which is coupled to the spindle via a harmonic drive. Here, the electric motor is seated at the outside on a steering gear housing upstream of the spindle.

Considering an on-board electrical system voltage of 24 V, such as is common in the utility vehicle sector, such electric motors conventionally generate a drive torque of 2 Nm, such that, considering a gear transmission ratio of the harmonic drive of i=50, a torque of around 100 Nm can be obtained. By contrast, the hydraulic component of the power assistance corresponds to a torque of approximately 7600 Nm.

A utility vehicle steering system of said type is of complex construction owing to the ball screw drive and the required hydraulic system. Furthermore, the hydraulic system gives rise to a considerable structural space requirement.

As discussed in DE 20 2004 021 588 U1, a permanently operationally ready hydraulic power assistance means requires a power of approximately 1000 W, which is manifest in corresponding additional fuel consumption. In DE 20 2004 021 588 U1, as a remedial solution, it is proposed that the hydraulic power assistance means be deactivated in certain situations such that only the electrical power assistance means is used. Only if relatively high steering forces are required is the hydraulic power assistance means activated.

Furthermore, DE 100 39 574 A1 discloses a utility vehicle steering system of the type mentioned in the introduction with purely electric power assistance. In this way, the outlay for an additional hydraulic system is avoided. For the purposes of redundancy, the utility vehicle steering system according to DE 100 39 574 A1 is equipped with two electric motors, which in turn gives rise to an increased structural space requirement and manufacturing outlay.

The present invention is based on the object of further developing a utility vehicle steering system of the type mentioned in the introduction, maintaining high steering forces and a compact design with regard to reduced outlay in terms of construction.

Said object is achieved by means of a utility vehicle steering system as per patent claim 1. The utility vehicle steering system according to the invention comprises a steering gear for transmitting a manual torque applied to a steering wheel to a steering pitman arm, which steering gear has an electric motor for providing an auxiliary torque, wherein the electric motor is arranged around a steering shaft or around a shaft on an axis of rotation of an output element of the steering gear, and has a stator with at least two electrically separate winding groups which are each actuated by a dedicated electronic control device.

It has been found that, with such an arrangement, a particularly compact utility vehicle steering system can be realized which permits the provision of high torques by means of an electromotive drive in a restricted structural space.

The utility vehicle steering system according to the invention is suitable in particular for non-rail-bound motor vehicles with front-axle loads of greater than 2.5 t.

The power assistance may be realized purely electrically, such that no hydraulic components are required. Here, the electrical supply may continue to be realized with the presently customary on-board electrical system voltage of 24 V.

In relation to systems with two separate electric motors, one stator-rotor assembly can be omitted, wherein the system redundancy is nevertheless maintained. The remaining single electric motor is furthermore accommodated in a particularly space-saving manner.

Furthermore, components which are cumbersome to manufacture, such as a ball screw drive, can be omitted.

Via the steering pitman arm, the steering commands are transmitted from the steering gear for example via a track rod linkage to the pivot bearings of the steered wheels. The steering gear operates without a toothed rack.

Further refinements of the invention are specified in the patent claims.

In one design variant, the steering shaft is coupled to the steering pitman arm by means of a speed reduction gear stage, which converts an input-side rotational movement into an output-side rotational movement in single-stage fashion such that the input-side axis of rotation and the output-side axis of rotation of said gear stage intersect one another or are skewed relative to one another. In this way, it is possible to realize considerably higher transmission ratios in relation to a ball screw drive, such that a further considerable torque boost is possible by means of said gear stage. Suitable gear stages are worm gears and bevel wheel and hypoid gears, without being restricted to these.

In particular with hypoid gears which have a high toothing quality, in accordance with DIN 3961, of ≤7 and preferably ≤5, it is possible in one stage to realize transmission ratios which are otherwise possible only with multi-stage spur wheel or bevel wheel gears.

As already mentioned, the steering assistance may be provided by the electric motor alone, and exclusively electrically, over the entire operating range, such that the problems associated with a hydraulic circuit are avoided.

Furthermore, the gear stage by means of which the steering shaft is coupled to the steering pitman arm may have a variable transmission ratio such that, in a range encompassing the central position of the steering system, steering movements at the steering wheel give rise to smaller wheel steer angles than steering movements in a range remote from the central position. It can be ensured in this way that, during straight-ahead travel, large steering movements are associated with a small wheel steer angle and, during parking, small steering movements are associated with a large wheel steer angle.

In a further design variant, the electric motor is coupled to the steering shaft by means of a speed reduction gear stage, which axially adjoins the electric motor and is likewise arranged around the steering shaft. In this way, the steering gear is made more compact, which furthermore promotes the successive installation into a steering gear housing.

Furthermore, the electric motor may be arranged axially between a torque sensor and the gear stage which couples the electric motor to the steering shaft. This makes it possible to provide a large axial spacing between the bearing arrangements of the steering shaft.

In a further design variant, the steering pitman arm has an axis of rotation. Furthermore, the electric motor is coupled by means of a speed reduction gear stage to the steering pitman arm, which gear stage is arranged around the axis of rotation of the steering pitman arm. In this case, the gear stage is thus arranged not around the steering shaft but around an output shaft which is driven by the steering shaft.

In a further design variant, the electric motor has two separately actuated sub-motors, the windings of which are nested one inside the other. For an unchanged on-board electrical system voltage, this yields practically a doubling of the torque provided by the single electric motor, with extremely compact dimensions.

Furthermore, the electric motor may have a central connector ring for the contacting of all windings of the winding groups, and connectors for the contacting of the electronic control devices.

In a further design variant, the electric motor, the first gear stage coupled between the electric motor and the steering shaft, and also the second gear stage arranged between the steering shaft and the steering pitman arm are accommodated in a steering gear housing, thus yielding a fully preassemblable unit that can subsequently be installed on the vehicle.

Furthermore, the steering pitman arm may be arranged on an output shaft extending out of the steering gear housing.

In a further design variant, the steering shaft is accommodated rotatably in the steering gear housing and has, in particular, a connector for the coupling of a steering wheel or of a steering column. A manual torque imparted to the steering shaft by the driver is thus, bypassing the first gear stage, subjected to a speed reduction with the transmission ratio of the second gear stage, whereas an auxiliary torque provided by the electric motor is subjected to a speed reduction with the transmission ratio of the first gear stage and with the transmission ratio of the second gear stage. In the event of a failure of the electric motor, the driver thus has to impart only low forces in order to overcome the inertias of the electric drive side.

The invention will be discussed in more detail below on the basis of exemplary embodiments illustrated in the drawing, in which:

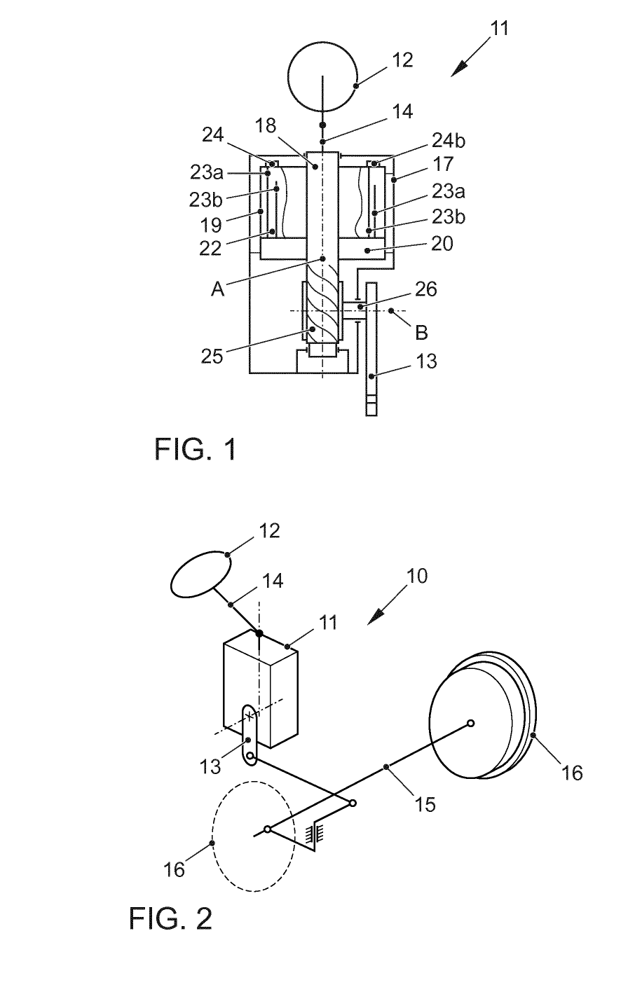

FIG. 1 shows a schematic view of a first exemplary embodiment of a utility vehicle steering system according to the invention,

FIG. 2 shows a schematic view of the arrangement of a utility vehicle steering system according to the invention on a utility vehicle,

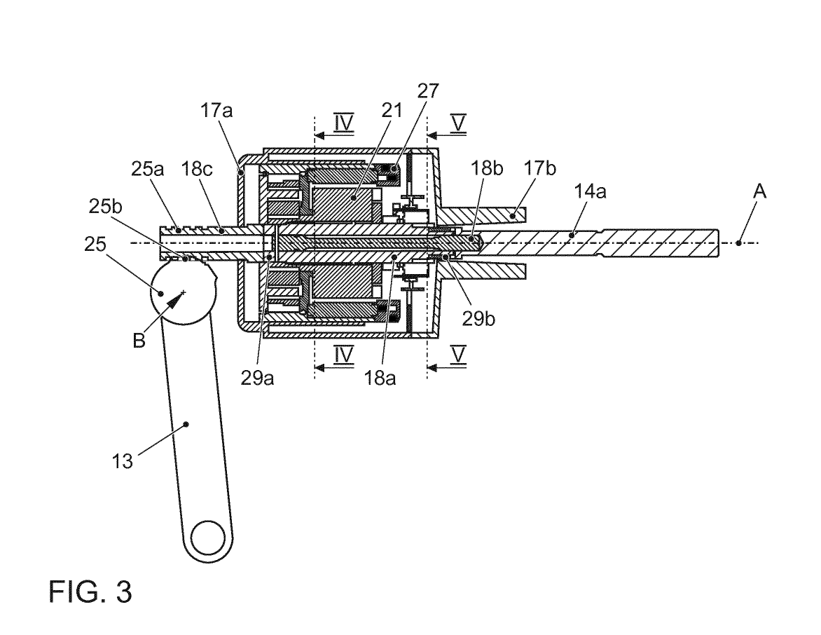

FIG. 3 shows a longitudinal sectional view of a second exemplary embodiment of a utility vehicle steering system according to the invention,

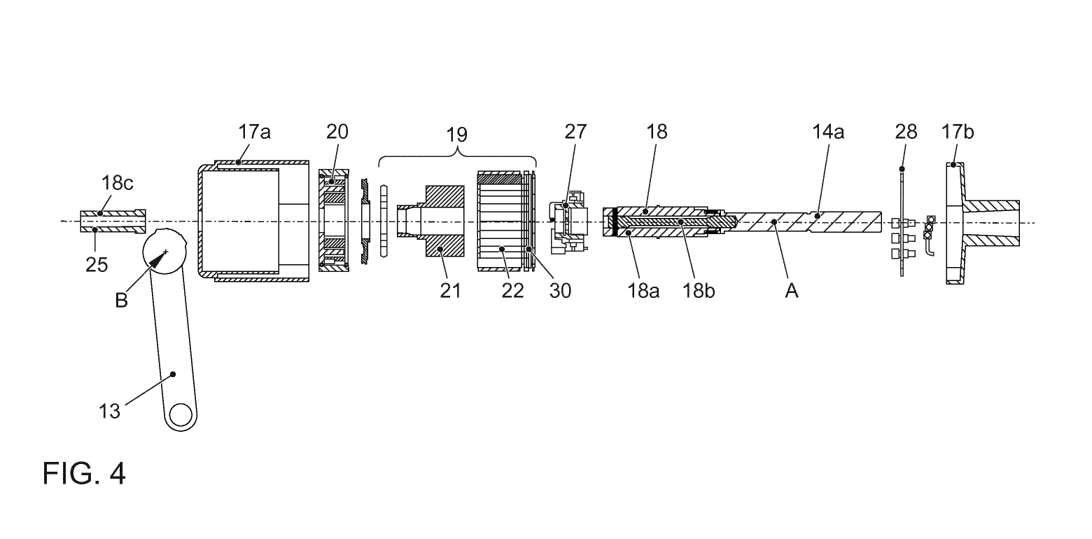

FIG. 4 is an exploded illustration of the second exemplary embodiment,

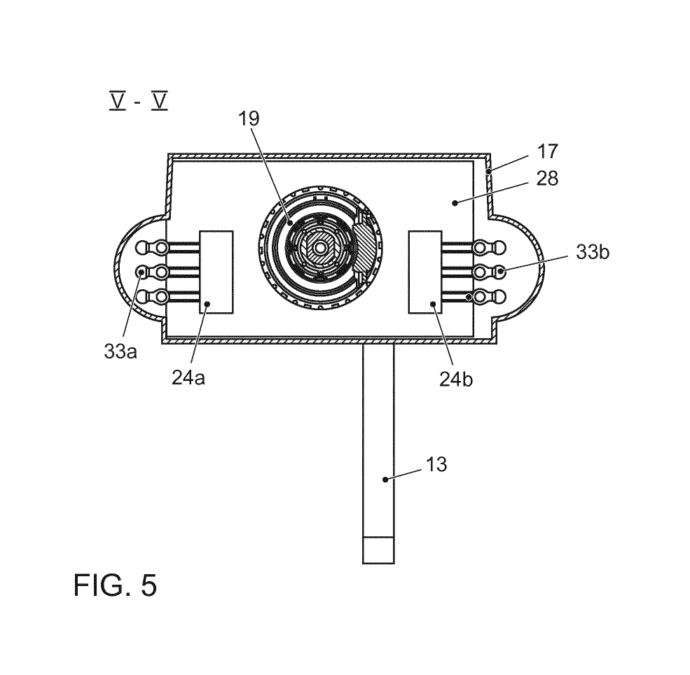

FIG. 5 shows a sectional view along the line V- in FIG. 3,

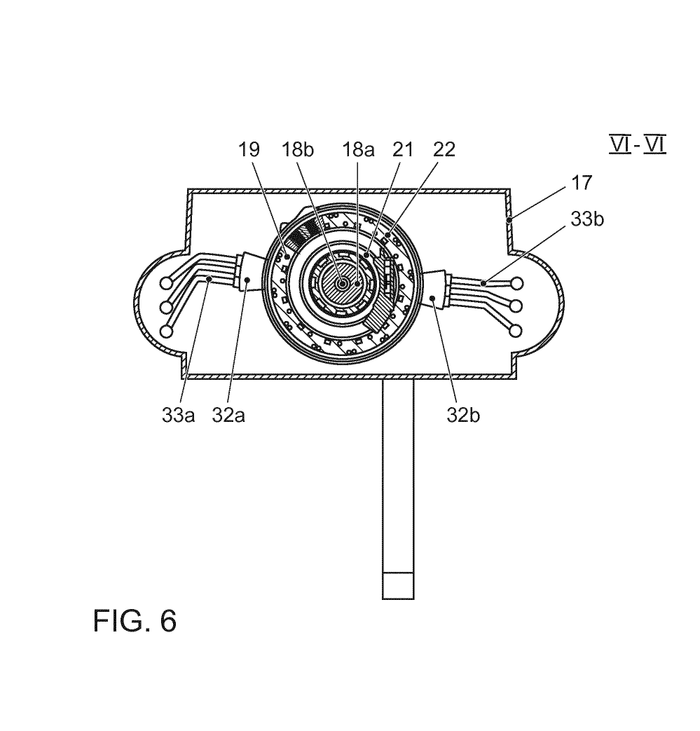

FIG. 6 shows a sectional view along the line VI-VI in FIG. 3,

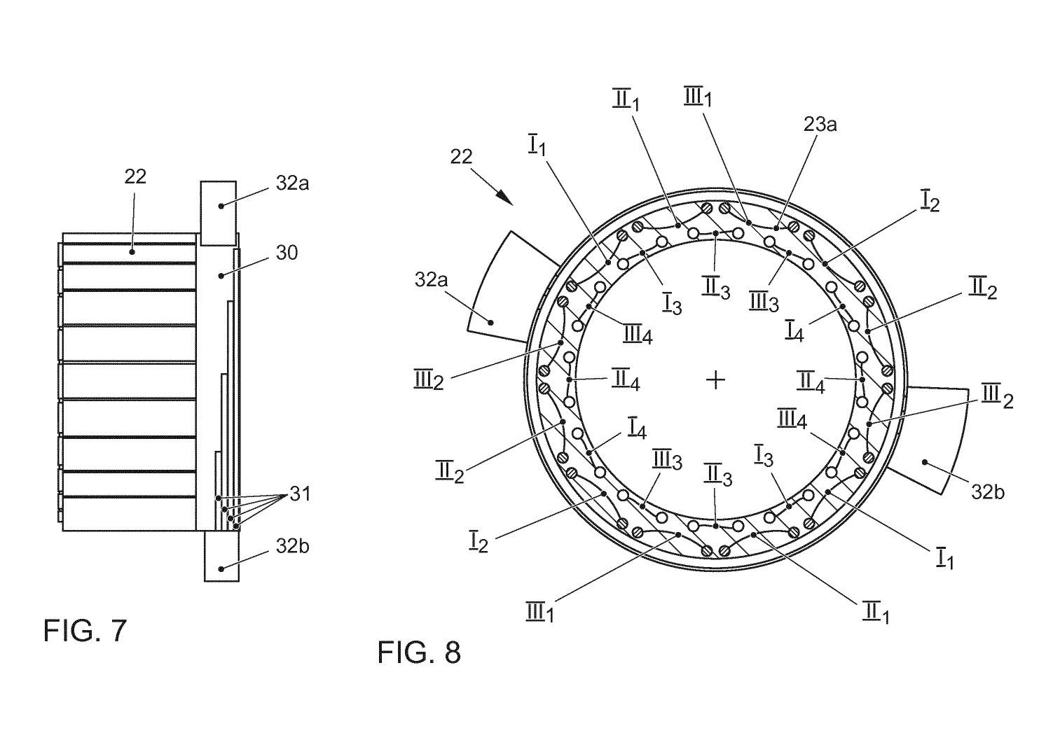

FIG. 7 shows a side view of the stator of the electric motor, and

FIG. 8 shows a view of the stator of the electric motor in section.

The exemplary embodiments each relate to a utility vehicle steering system 10 of a block steering system type, which is suitable for front-axle loads of 2.5 t and higher. FIG. 2 shows, in a schematic illustration, the arrangement thereof in a utility vehicle.

The utility vehicle steering system 10 has a steering gear 11 which is intended and designed for transmitting a manual torque imparted by the driver at a steering wheel 12 to a steering pitman arm 13. For this purpose, the steering wheel 12 is coupled via a steering column 14 to an input element of the steering gear 11. The steering pitman arm 13, which is coupled to an output element of the steering gear 11, is connected for example via a track rod linkage 15 to the wheels 16, which are to be steered, of the motor vehicle, in order to transmit a pivoting movement of the steering pitman arm 13 to the wheels 16 and thus effect a steer angle at said wheels.

The steering gear 11 has a steering gear housing 17, in which steering shaft 18 is arranged so as to be rotatable about an axis of rotation A. The steering shaft 18 is acted on at the input of the steering gear 11 by the steering column 14, with the manual torque generated by the driver, so as to correspondingly rotate.

Furthermore, in the steering gear housing 17, there is accommodated an electric motor 19, which is arranged around the steering shaft 18. The electric motor 19 is preferably designed as a hollow-shaft motor, the axis of rotation of which is coaxial with respect to the axis of rotation A of the steering shaft 18.

A drive torque provided by the electric motor 19 is transmitted by means of a first gear stage 20 to the steering shaft 18 in order to assist the driver when steering. The first gear stage 20 is preferably in the form of a high-ratio coaxial gear, which couples a rotor of the electric motor 19 to the steering shaft 18. In particular, said first gear stage may be designed as a single-stage or multi-stage planetary gear set of two-shaft construction, as a cycloid gear, as a harmonic drive or as a combination of these. It is thus possible to realize speed reduction transmission ratios in the range from 1:15 to 1:400.

The electric motor 19 is actuated in a manner dependent on a driver steering command and possibly further vehicle parameters. In particular, the electric motor 19 may be actuated in a manner dependent on the manual torque imparted to the steering wheel 12 by the driver.

In the present case, the auxiliary force that assists the driver is generated exclusively electrically, and by a single electric motor 19 alone. In order, in a utility vehicle steering system, to generate adequate steering forces for the track rod linkage 15 from an on-board electrical system voltage of 24 V, the electric motor 19 has a stator 22 with at least two electrically separate winding groups 23a and 23b, which are each actuated by a dedicated electronic control device 24a and 24b, such that the two winding groups 23a and 23b are supplied with electrical current independently of one another from the on-board electrical system. In this way, the electric motor 19 is capable of providing a relatively high drive torque.

The steering shaft 18 is coupled by means of a second gear stage 25 to the steering pitman arm 13. For this purpose, the latter is fastened to an output element of the second gear stage 25 or to an output shaft 26 connected to said output element.

The second gear stage 25 is preferably a speed reduction gear stage. In particular, said gear stage may be designed such that an input-side rotational movement is converted into an output-side rotational movement in single-stage fashion. Here, the input-side axis of rotation, that is to say the axis of rotation A of the steering shaft 18, and the output-side axis of rotation B of the second gear stage 25 intersect one another, or are skewed relative to one another. By means of the second gear stage 25, the auxiliary torque acting at the steering pitman arm 13 is increased further, such that high steering forces track rod linkage 15 can be with a small, high-speed electric motor 19.

The second gear stage 25 may be designed for example as a worm drive, a bevel wheel stage or a hypoid gear stage. Here, as already mentioned, it is possible to realize a further considerable speed reduction transmission ratio with a transmission ratio in the range from 1:2 to 1:100, preferably in the range from 1:5 to 1:30.

The coaxial arrangement of the electric motor 19 around the steering shaft 18 yields a very compact and thus space-saving configuration of the steering gear 11.

A manual torque imparted to the steering shaft 18 by the driver is subjected to a speed reduction with the transmission ratio of the second gear stage 25, whereas the auxiliary torque provided by the electric motor 19 is subjected to a speed reduction with the transmission ratio of the first gear stage 20 and with the transmission ratio of the second gear stage 25.

In a modification of the first exemplary embodiment illustrated in FIG. 1, the first gear stage 20 may also be arranged around the axis of rotation B of the steering pitman arm 13, in particular coaxially with respect to the output shaft 26.

In a further modification, the second gear stage 25, by means of which the steering shaft 18 is coupled to the steering pitman arm 13, has a variable transmission ratio. In a range encompassing the central position of the steering system, steering movements at the steering wheel 12 give rise to smaller wheel steer angles than steering movements in a range remote from the central position.

On the basis of FIGS. 3 to 8, in the context of a second exemplary embodiment, but expressly without restriction thereto, a further specific possible implementation for a utility vehicle steering system 10 will be discussed in more detail. Here, components corresponding to the first exemplary embodiment are denoted by the same reference designations.

The steering gear 11 of the second exemplary embodiment comprises a steering gear housing 17 with a pot-shaped receiving section 17a, which is closed off axially by a cover 17b.

In the steering gear housing 17, a steering shaft 18 is mounted so as to be rotatable about an axis of rotation A. The steering shaft comprises a hollow-shaft section 18a, through which a torsion bar 18b extends. Via a steering column section 14a, the manual torque from the driver is introduced into a first end section of the torsion bar 18b, which at its second end section is connected rotationally conjointly to the hollow-shaft section.

The manual torque from the driver, which acts at the input side on the steering gear 11, can be detected, for the purposes of actuating the electric motor 19 that is likewise accommodated in the steering gear housing 17, by means of a torque sensor 27 that interacts with the steering shaft 18.

The electric motor 19 is arranged coaxially around the steering shaft 18 and is coupled to the latter by means of a first gear stage 20, which in the present case is for example designed as a high-ratio coaxial gear in the form of an eccentric gear, for example a cycloid gear. Instead of a cycloid gear of said type, it is however also possible to use the gear types already mentioned above, specifically planetary gears or harmonic drives.

The first gear stage 20 is connected at the input side to a rotor 21 of the electric motor 20, whereas the output element of the first gear stage 20 is fastened rotationally conjointly on the hollow shaft section 18a.

The first gear stage 20 effects a speed reduction of the rotational speed of the electric motor 19 with a transmission ratio in the range from 1:15 to 1:400. In the second exemplary embodiment illustrated, said first gear stage is arranged around the steering shaft 18, and axially adjoins the electric motor 19.

As shown in FIGS. 3 and 4, during the assembly process, the first gear stage 20 is introduced axially into the receiving section 17a of the steering gear housing 17 first, followed by the electric motor 19 and subsequently the torque sensor 27 and furthermore a cabling circuit board 28, before the steering gear housing 17 is closed off by means of the cover 17b. The electric motor 19 is thus arranged axially between the torque sensor 27 and the first gear stage 20, which couples the electric motor 19 to the steering shaft 18. This yields a highly compact structural unit with a large axial spacing for the bearing points 29a and 29b of the steering shaft 18.

The steering shaft 18 of the second exemplary embodiment furthermore has a spindle section 18c, which serves as an input element 25a of a second gear stage 25. The spindle section 18c meshes with a worm wheel 25b of the second gear stage 25, which worm wheel rotates about an axis of rotation B perpendicular to the axis of rotation A of the steering shaft 18. The worm wheel 25b, which may also have a toothing only in the form of segments, is coupled rotationally conjointly to the steering pitman arm 13, whereby the manual torque and the auxiliary torque give rise to a pivoting movement of the steering pitman arm 13 about the axis of rotation B.

In the illustrated second exemplary embodiment, the steering shaft 18 projects with the spindle section 18c out of the steering gear housing 17. The second gear stage 25 is also arranged outside the steering gear housing 17. It is however possible for the second gear stage 25 to also be accommodated in the steering gear housing 17. It is furthermore possible for the assembly illustrated in FIG. 3, aside from the steering pitman arm 13, to be enclosed by an additional outer housing (not illustrated in any more detail).

The electric motor 20 and the contacting thereof are illustrated in more detail in FIGS. 5 to 8. Said electric motor has a stator 22 which is fixed in the steering gear housing 17 and in which a rotor 21, which is connected to the input side of the first gear stage 20, is rotatably arranged.

As already discussed above in conjunction with the first exemplary embodiment, the stator 22 has at least two, that is to say two or more, electrically separate winding groups. In the illustrated second exemplary embodiment, by way of example, only two electrically independent winding groups 23a and 23b are illustrated, which in the present case are arranged at two different diameters about the axis of rotation A.

Each of the two winding groups 23a and 23b has three phases (Iᵢ, IIᵢ, IIIᵢ). FIG. 8 shows a total of 12 coils per winding group 23a and 23b, such that, for each winding group 23a and 23b, the number of pole pairs is 2. The rotor 21 (not illustrated in any more detail) is accordingly formed with in each case six phase laminations. It is however also possible to provide winding groups 23a and 23b with smaller or greater numbers of pole pairs.

It is furthermore possible for the winding groups 23a and 23b to be arranged offset with respect to one another in a circumferential direction, such that the phases are also offset in the circumferential direction, as illustrated in FIG. 8. However, the offset of the phases between the windings of the two winding groups 23a and 23b may also be greater than the spatial offset of the windings.

All of the windings have been contacted by means of a common connector ring 30, which has corresponding conductors 31 which are electrically insulated with respect to one another. Said conductors are connected to electrical contact devices 32a and 32b which are likewise arranged on the connector ring, and which may be formed for example as plug connectors. A dedicated electrical contact device 32a and 32b is provided for each winding group 23a and 23b.

The electrical contact devices 32a and 32b are each connected by means of further electrical conductors 33a and 33b to an associated electronic control device 24a and 24b, such that each winding group 23a and 23b is actuated by a dedicated control device 24a and 24b and is supplied separately with electrical current from the vehicle on-board electrical system. This thus yields two electric sub-motors, which are nested one inside the other.

The electronic control devices 24a and 24b are preferably likewise accommodated in the steering gear housing 17, and for example attached to a circuit board 28 arranged axially in front of a face side of the electric motor 19.

The exemplary embodiments discussed above make it possible to realize a particularly compact utility vehicle steering system, which permits the provision of high auxiliary torques by means of a single electromotive drive in a limited structural space. Said drive can in particular be operated from a vehicle on-board electrical system with a supply voltage of 24 V.

With regard to the electromotive assistance, the steering gear 11 forms, by means of at least two sub-motors integrated into a common stator-rotor assembly, a redundant system that can continue to be operated in the event of a failure of one sub-motor.

The transmission ratios of the gear stages may possibly be set such that the steering system remains steerable manually even in the event of a total failure of the electric motor 19.

Owing to the use of an electric motor 19 with a high power output, a hydraulic power assistance arrangement can be omitted entirely. As a result of the arrangement of the electric motor 11 around the steering shaft 18, the steering gear 11 nevertheless remains surprisingly compact. This is further enhanced by means of a high-ratio gear stage connected downstream of the electric motor 11.

The utility vehicle steering system according to the invention is moreover characterized by relatively easily producible components.

The invention has been discussed in more detail above on the basis of various exemplary embodiments and further modifications. In particular, technical individual features that have been discussed above in the context of further individual features may be realized independently of these and in combination with further individual features, even if this is not expressly described, as long as this is technically possible. The invention is therefore explicitly not restricted to the described exemplary embodiments, but rather encompasses all refinements defined by the patent claims.

### LIST OF REFERENCE SYMBOLS

10 Steering system
11 Steering gear
12 Steering wheel
13 Steering pitman arm
14 Steering column
14 Steering column section
15 Track rod linkage
16 Vehicle wheel
17 Steering gear housing
17a Receiving section
17b Cover
18 Steering shaft
18a Hollow shaft section
18b Torsion bar
18c Spindle section
19 Electric motor
20 First gear stage
21 Rotor
Stator
23a Winding group
23b Winding group
24a Electronic control device
24b Electronic control device
25 Second gear stage
25a Worm shaft section
25b Worm wheel
26 Output shaft
27 Torque sensor
28 Circuit board
29a Bearing point of the steering shaft
29b Bearing point of the steering shaft
30 Connector ring
31 Conductor
32a Electrical contact device
32b Electrical contact device
33a Further conductor
33b Further conductor
A Axis of rotation of the steering shaft and of the electric motor
B Axis of rotation of the output element of the steering gear and of the steering pitman arm

1-10. (canceled)

11. A utility vehicle steering system, comprising:
a steering gear for transmitting a manual torque applied to a steering wheel to a steering pitman arm, said steering gear having a steering shaft and an output element with a shaft with a given axis of rotation;
said steering gear having an electric motor for providing an auxiliary torque disposed around said steering shaft or around said shaft of said output element; and
said electric motor having a stator with at least two electrically separate winding groups that are each actuated by a respective, dedicated electronic control device.

12. The utility vehicle steering system according to claim 11, which comprises a speed reduction gear stage coupling said steering shaft to said steering pitman arm, said speed reduction gear stage converting an input-side rotational movement into an output-side rotational movement in a single-stage such that an input-side axis of rotation and an output-side axis of rotation of said gear stage intersect one another or are skewed relative to one another.

13. The utility vehicle steering system according to claim 11, wherein said electric motor is a single electric motor configured to provide steering assistance alone, and exclusively electrically, over an entire operating range.

14. The utility vehicle steering system according to claim 11, which comprises a speed reduction gear stage coupling said steering shaft to said steering pitman arm, said gear stage having a variable transmission ratio such that, in a range encompassing a central position of the steering system, steering movements at the steering wheel give rise to smaller wheel steer angles than steering movements in a range remote from the central position.

15. The utility vehicle steering system according to claim 11, which comprises a speed reduction gear stage coupling said electric motor to said steering shaft, said speed reduction gear stage axially adjoining said electric motor and being arranged around said steering shaft.

16. The utility vehicle steering system according to claim 15, wherein said electric motor is arranged axially between a torque sensor and said speed reduction gear stage that couples said electric motor to said steering shaft.

17. The utility vehicle steering system according to claim 11, which comprises a speed reduction gear stage coupling said electric motor to said steering pitman arm and being disposed around an axis of rotation of said steering pitman arm.

18. The utility vehicle steering system according to claim 11, wherein said electric motor has two separately actuated partial motors, said partial motors having windings that are nested one inside the other.

19. The utility vehicle steering system according to claim 11, wherein said electric motor has a central connector ring for contacting all windings of said winding groups and electrical contact devices for a connection of said electronic control devices.

20. The utility vehicle steering system according to claim 11, wherein:
said steering shaft is accommodated rotatably in a steering gear housing and has a connector for mounting a steering wheel or a steering column;
said steering pitman arm is arranged on an output shaft projecting out of said steering gear housing;
said electric motor and a first gear stage coupled between said electric motor and said steering shaft are accommodated in said steering gear housing;
a second gear stage is arranged between said steering shaft and said steering pitman arm;
wherein a manual torque imparted to said steering shaft by a driver of the vehicle is subjected to a speed reduction with a transmission ratio of the second gear stage, and an auxiliary torque provided by said electric motor is subjected to a speed reduction with a transmission ratio of said first gear stage and with the transmission ratio of said second gear stage.

21. The utility vehicle steering system according to claim 20, wherein said second gear stage is accommodated in said steering gear housing together with said electric motor and said first gear stage.
